(19) United States
(12) Patent Application Publication
(10) Pub. No.: US 2023/0286842 A1
(43) Pub. Date: Sep. 14, 2023

(54) COMPOSITIONS AND METHODS FOR TREATING AQUARIUM WATER

(71) Applicant: Spectrum Brands, Inc., Middleton, WI (US)

(72) Inventors: Birgit BURG, Middleton, WI (US); Michael BUSCHMANN, Middleton, WI (US); Heike HOLSCHER, Middleton, WI (US)

(73) Assignee: Spectrum Brands, Inc., Middleton, WI (US)

(21) Appl. No.: 18/017,044

(22) PCT Filed: Jul. 20, 2021
(86) PCT No.: PCT/US2021/042343

§ 371 Date: Jan. 19, 2023

Related U.S. Application Data
(60) Provisional application No. 63/054,465, filed on Jul. 21, 2020.

(51) Int. Cl. C02F 1/68; C02F 1/52; C02F 1/56; A01K 63/04

(52) U.S. Cl. CPC C02F 1/683; C02F 1/5245; C02F 1/5263; C02F 1/56; C02F 1/5272; A01K 63/04; C02F 2101/105

(57) ABSTRACT

The present disclosure provides compositions and methods of use for effectively treating aquarium water in long term. The compositions include various components functioning to improve water quality, reduce or remove inorganic nitrogen and phosphorus, stabilize buffer capacity, and provide other advantages to aquarium water. Methods of using the compositions to improve the efficiency of treating aquarium water are also provided. The compositions and methods of the present disclosure can improve prophylaxis against unfavorable aquatic plant such as algae and extend life of animals in aquarium water.

### CROSS-REFERENCE TO RELATED APPLICATION

This application is a PCT International Patent Application and claims priority to U.S. Provisional Patent Application No. 63/054,465, filed Jul. 21, 2020, the disclosure of which is hereby incorporated by reference in its entirety.

### INTRODUCTION

An aquarium is a delicately balanced ecosystem that relies on good quality to keep beneficial animals therein, such as fish, vital and healthy. There are many factors affecting the quality of aquarium water.

Ammonia is a natural waste product of fish metabolism and if it builds up in aquarium water it is very harmful. Accumulated ammonia in excessive amount in aquarium water will cause significant distress or sudden death of fish. Inorganic nitrogen such as nitrite follows closely on the heels of ammonia as a major killer of aquarium fish. The presence of excessive nitrite makes aquarium water toxic and can cause poor appetite, inactivity, fish hanging out by the water filter outflow, and brown colored gills of aquarium. Notably, anytime ammonia levels are elevated, increased nitrite will soon follow, and can quickly be lethal. Inorganic nitrite in aquarium water increases naturally and constantly without effective treatment. It is thus desirable to reduce or minimize ammonia and inorganic nitrogen in aquarium water.

Inorganic phosphorus such as phosphate is constantly present in aquarium. Phosphate can be found in tap water, and is also in the food given to fish and can accumulate in aquarium water. If the aquarium is not properly maintained, the phosphate levels will rise and contribute to growth of unwanted algae. The results are unsightly in an aquarium tank. It is desirable to minimize or eliminate inorganic phosphorus in aquarium water.

Algae growth is a fact of life in aquarium water. Although some algae growth is normal and healthy, excessive algae is unsightly and can be hazardous to fish and other beneficial lives. Excess lighting, too much fish food, and lack of sufficient filtration/purification can substantially increase algae growth in aquarium and thereby detrimentally affect the fish health. Algae growth in large part depends on the nitrogen and phosphorus, both as nutritional sources of aquarium water. Unnecessarily high content of inorganic nitrogen and phosphorus will facilitate growth of unwanted algae, thereby threatening the fish health. It is highly desirable to reduce or inhibit algae growth and improve prophylaxis against unfavorable plants in aquarium water.

Minerals and metal ions can significantly affect the acid-base balance (pH=power of Hydrogen), and alkalinity (KH=Carbonate Hardness) of aquarium water, all of which are important factors to water quality. It is desirable to control mineral content and maintain constant pH and KH in an aquarium, benefiting fish health, vitality, and environmental adaption.

Water change in excessive frequency, for example, more than 6 times per month may affect fish vitality in aquarium. Anything that suddenly and significantly changes the aquatic environment may contribute negatively to quality maintenance. The amount of water change at once and all the factors from temperature to pH and chemical composition to bacterial colonies may adversely affect fish life and vitality. Moreover, frequent water change is generally disfavored by aquarium owners because it is time consuming and inconvenient. It is thus highly desirable to reduce or minimize water change cycle.

In addition to the above factors, it is also desirable to introduce nutritional, or other beneficial components into aquarium water to advantageously promote health and extend life of fish therein, while not negatively affecting water quality.

Compositions and methods for treating aquarium water and improving water quality have been disclosed. CA 2,382,949 to Ritter discloses a process for the improvement of water quality of biological maintenance systems by treating aquarium water with compositions for lowering the phosphate and nitrate concentration, increasing the carbonate hardness, and increasing the CO₂ concentration.

U.S. Pat. No. 6,979,411 to Ritter discloses a water treatment composition comprising soluble metal salt of an organic carboxylic acid, water-soluble N-free, biologically decomposable organic compound, and soluble alkali metal salt of an organic carboxylic acid, and optionally trace elements and vitamins.

U.S. Pat. No. 7,244,358 to Ritter discloses agents for the removal or reduction of inorganic nitrogen compounds, especially nitrate, from biological aquarium waters, containing a biologically degradable polymer, preferably polycaprolactone (PCL).

US 2016/0152498 to Klooster discloses agents comprising a hybrid biologically degradable polymer-metal complex for the removal or reduction of inorganic compounds, preferably nitrogen and phosphate compounds, from an aqueous solution.

U.S. Pat. No. 6,477,982 to Ritter discloses an agent for reducing the negative or harmful effects to aquatic animal life comprising tartaric acid, formate, magnesium ions, and correction additives.

U.S. Pat. No. 7,836,851 to Gergely discloses formulations for treating water used to hold captive fish in tanks comprising an ammonia remover, a chlorine remover, a bacterial and fungal spore remover, an anti-columnaris and saprolegnia agent, a disinfectant, a slime-coating protecting agent, a chelating agent and a surface foam remover.

In spite of the above disclosures, it is still highly desirable to improve efficacy of water treatment compositions, to improve the effectiveness of eliminating unwanted materials, to enhance the overall efficiency of quality maintenance with less use or dosage of agents, and to maintain quality of aquarium water constantly high. In addition, many problems are inter-related, and solving one problem may unfavorably worsen another problem. Therefore, it is challenging to make a water treatment composition having all needs stated herein in a single composition. It is against the above background the present disclosure is provided to demonstrate advantage and advancement.

Compositons and Methods for Treating Aquarium Water

### SUMMARY OF DISCLOSURE

The present disclosure generally relates to compositions and methods for treating aquarium water that provide a number of advantages. The compositions of the present disclosure comprises various functional components that synergistically function to improve the water quality of aquarium water and maintaining the water quality constantly high. The compositions and methods of the present disclosure significantly improve the efficiency of eliminating unwanted inorganic nitrogen and/or phosphate, stabilize buffer capacity and maintain constant pH and KH surprisingly constant over a long period of time, and provide other nutritional and beneficial value to aquarium water. The compositions and methods of the present disclosure can significantly increase prophylaxis against unfavorable aquatic plant such as algae and extend life of beneficial animals like fish and other tank inhabitants in aquarium water.

In some embodiments, the present disclosure relates to a composition for treating aquarium water comprising: a first formulation for reducing or removing inorganic nitrogen and/or inorganic phosphorus in aquarium water; and a buffer. In certain embodiments, the composition further comprises at one or more metal chelating agent. The metal chelating agent may be a complex agent comprising one or more chelating units. The chelating units of the metal chelating agent may be N(CH(R¹)R²COOH) or conjugate anion thereof, wherein IV is H or alkyl group, and R² is absent or an alkyl group. Examples of a metal chelating agent include but are not limited to ethylenediaminetetraacetic acid (EDTA), methylglycinediacetic acid, corresponding conjugate anions thereof, or combinations thereof. The metal chelating agent may further comprise a metal ion such as Fe³⁺, or Al³⁺, or combination thereof. A non-limiting example of the complex agent may be Fe(III)-EDTA. In some embodiment, the present composition further comprises a tea tree oil or extract thereof. In some embodiments, the composition comprises a second formulation consisting essentially of a tea tree oil, a solvent, and a thickener. In some embodiments, the present composition optionally comprises a thickener, or a mineral concentrate, or a vitamin concentrate, or a preservative, or combinations thereof.

In some embodiments, the present disclosure relates to an aqueous composition for treating aquarium water comprising: a first formulation for reducing or removing inorganic nitrogen and/or inorganic phosphorus in aquarium water; a buffer; and water. In some embodiments, the aqueous composition further comprises one or more metal chelating agent. In other embodiments, the aqueous composition further comprises a tea tree oil of extract thereof. In yet other embodiments, the aqueous composition comprises a second formulation consisting essentially of a tea tree oil, a solvent, and a co-emulsifier.

In some embodiments, the present disclosure relates to an aqueous composition for treating aquarium water comprising a first formulation, a buffer, one or more metal chelating agent, and water. In at least these example embodiments the first formulation comprises a first agent and a second agent, wherein the first agent comprises a biodegradable polyester, wherein the first agent is from about 0.1 wt % to about 10 wt %, or from about 0.5 wt % to about 8 wt %, from about 1 wt % to about 6 wt %, or from about 1 wt % to about 4 wt %; a second agent; wherein the second agent comprises a metal carboxylate, wherein the second agent is from about 0.01 wt % to about 5 wt %, or from about 0.05 wt % to about 4 wt %, or from about 0.1 wt % to about 3 wt %, or from about 0.2 wt % to about 2 wt %, or from about 0.3 wt % to about 1 wt %, or from about 0.4 wt % to about 1 wt %. In related example embodiments the buffer comprises one or more neutralized fruit acid(s), wherein the buffer is from about 0.1 wt % to about 20 wt %, or from about 0.5 wt % to about 15 wt %, or from about 1 wt % to about 10 wt %, or from about 2 wt % to about 8 wt %, or from about 2.5 wt % to about 6 wt %. Moreover, the metal chelating agent may also comprise one or more N(CH(R¹)R²COOH) or conjugate anion thereof, wherein R¹ is H or alkyl group, and R² is absent or an alkyl group, and wherein the metal chelating agent is from about 0.001 wt % to about 1 wt %, or from about 0.005 wt % to about 0.5 wt %, or from about 0.01 wt % to about 0.15 wt %, or from about 0.01 wt % to about 0.1 wt %, or from about 0.02 wt % to about 0.05 wt %, wherein the wt % is based on the total weight of the composition.

In certain embodiments, the present aqueous composition optionally comprises a tea tree oil or extract thereof, wherein the tea tree oil is from about 0.01 wt % to about 1 wt %, or from about 0.05 wt % to about 0.5 wt %, or from about 0.05 wt % to about 0.15 wt %, or from about 0.1 wt % to about 0.15 wt %, wherein the wt % is based on the total weight of the composition.

In some embodiments, the present aqueous composition optionally comprises a second formulation consisting essentially of a tea tree oil, a solvent, and a co-emulsifier, wherein the solvent is selected from the group consisting of glycerol, 1,2-propylene glycol, propylene glycol, dipropylene glycol, hexylene glycol, or combinations thereof, wherein the co-emulsifier is selected from the group of cornstarch, cellulose, carboxymethyl cellulose (CMC), pre-gelatinized starch, arrowroot, agar-agar, carrageenan, gum arabic or acacin, gum tragacanth, pectin, or combinations thereof. In some embodiments, the tea tree oil of the second formulation is from about 0.01 wt % to about 1 wt %, or from about 0.05 wt % to about 0.5 wt %, or from about 0.05 wt % to about 0.15 wt %, or from about 0.1 wt % to about 0.15 wt %, wherein the wt % is based on the total weight of the aqueous composition. In some embodiments, the solvent of the second formulation is from about 0.5 wt % to about 10 wt %, or from about 1 wt % to about 5 wt %, or from about 1 wt % to about 3 wt %, or from about 1 wt % to about 2 wt %, wherein the wt % is calculated based on the total weight of the aqueous composition.

In some embodiments, the present disclosure relates to a method of treating aquarium water comprising adding/applying a composition to aquarium water, wherein the composition comprises: a first formulation for reducing or removing inorganic nitrogen and/or inorganic phosphorus in aquarium water; and a buffer. In some embodiments, the composition of the present method comprises one or more metal chelating agent. In some embodiments, the composition further comprises a tea tree oil or extract.

In certain embodiments, the present disclosure relates to a method of treating aquarium water comprising adding/applying a composition to aquarium water, wherein the composition comprises: a first formulation, a buffer, one or more metal chelating agent, and water. In related embodiments, the first formulation comprises: a first agent, wherein the first agent comprises a biodegradable polyester, wherein the first agent is from about 0.1 wt % to about 10 wt %, or from about 0.5 wt % to about 8 wt %, from about 1 wt % to about 6 wt %, or from about 1 wt % to about 4 wt %; a second agent, wherein the second agent comprises a metal carboxylate, wherein the second agent is from about 0.01 wt % to about 5 wt %, or from about 0.05 wt % to about 4 wt %, or from about 0.1 wt % to about 3 wt %, or from about 0.2 wt % to about 2 wt %, or from about 0.3 wt % to about 1 wt %, or from about 0.4 wt % to about 1 wt %. Additionally, these embodiments are formulated in a manner where the buffer may comprise one or more neutralized fruit acid(s), wherein the buffer is from about 0.1 wt % to about 20 wt %, or from about 0.5 wt % to about 15 wt %, or from about 1 wt % to about 10 wt %, or from about 2 wt % to about 8 wt %, or from about 2.5 wt % to about 6 wt %. Additionally, the metal chelating agent comprises one or more N(CH(R¹)R²COOH) or conjugate anion thereof, wherein IV is H or alkyl group, and R² is absent or an alkyl group, and wherein the metal chelating agent is from about 0.001 wt % to about 1 wt %, or from about 0.005 wt % to about 0.5 wt %, or from about 0.01 wt % to about 0.15 wt %, or from about 0.01 wt % to about 0.1 wt %, or from about 0.02 wt % to about 0.05 wt %, wherein the wt % is calculated based on the total weight of the composition.

In some embodiments, the present method of treating aquarium water comprises adding/applying an aqueous composition into aquarium water according to the present disclosure, wherein the total amount of the aqueous composition is from about 50 mL to about 200 mL per 100 L of aquarium water, or from about 50 mL to about 100 mL per 100 L of aquarium water, or from about 100 mL to about 150 mL per 100 L of aquarium water, or from about 150 mL to about 200 mL per 100 L of aquarium water. In certain embodiments, the present method comprises adding an aqueous composition into aquarium water at least once per month, wherein the total amount of the aqueous composition is from about 75 mL to about 125 mL per 100 L of aquarium water, and wherein the aqueous composition comprises from about 1 wt % to about 4 wt % of a biodegradable polyester; from about 0.4 wt % to about 1 wt % of a metal carboxylate; from about 2.5 wt % to about 6 wt % of a buffer; from about 0.02 wt % to about 0.05 wt % of one or more metal chelating agent; and optionally from about 0.05 wt % to about 0.15 wt % of a tea tree oil of extract thereof.

In practicing the present methods, a person having ordinary skill in the art will be capable of calculating the dosage and frequency based on the total amount of the composition required to use. In some embodiments, the present method comprises adding/applying the composition into aquarium water at a frequency of once per month. In other embodiments, the present method comprises adding the composition into aquarium water at a frequency of twice per month (equivalent to a biweekly interval between two application in a month), or three times per month, or four times per month (equivalent to a weekly interval between two successive applications in a month).

In some embodiments, the present method comprises adding/applying an effective amount of the present composition comprising one or more metal chelating agent to aquarium water, wherein the method operatively enables the aquarium water to have a stable concentration of chelating agent from about 0.01 mg/L to about 0.5 mg/L per month, or from about 0.01 mg/L to about 0.3 mg/L per month, or from about 0.02 mg/L to about 0.5 mg/L per month, or from about 0.02 mg/L to about 0.25 mg/L per month, or from about 0.02 mg/L to about 0.15 mg/L per month, or from about 0.05 mg/L to about 0.25 mg/L per month, or from about 0.05 mg/L to about 0.15 mg/L per month, or from about 0.1 mg/L to about 0.2 mg/L per month for at least 14 weeks. In other embodiments, the present method operatively enables the aquarium water to have a stable concentration of soluble metal ions from about 0.01 mg/L to about 0.5 mg/L per month, or from about 0.01 mg/L to about 0.3 mg/L per month, or from about 0.02 mg/L to about 0.5 mg/L per month, or from about 0.02 mg/L to about 0.25 mg/L per month, or from about 0.02 mg/L to about 0.15 mg/L per month, or from about 0.05 mg/L to about 0.25 mg/L per month, or from about 0.05 mg/L to about 0.15 mg/L per month, or from about 0.1 mg/L to about 0.2 mg/L per month for at least 14 weeks. In certain embodiments, the metal ion comprises Al³⁺, or Fe³⁺, or combinations thereof. In some embodiments, the present method operatively enables aquarium water to have a phosphate concentration of less than about 2 mg/L for at least about 14 weeks. In some embodiments, the present method operatively enables aquarium water to have a nitrate concentration of less than about 25 mg/L for at least about 14 weeks.

Definitions and Interpretations of Terms

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %, etc.

As used herein, “g” represents gram; “L” represents liter; “mg” represents “milligram (10⁻³ gram);” “mL” represents milliliter (10⁻³ liter); “nm” represents nanometer (10⁻⁹ meter); micrometer is 10⁻⁶ meter. The units “mg/100 g,” “mg/100 mL,” or “mg/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius (° C.).

The term “about” is used in conjunction with numeric values to include normal variations in measurements as expected by persons skilled in the art, and is understood have the same meaning as “approximately” and to cover a typical margin of error, such as +10% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

Aquarium herein broadly encompass any biological tank systems, including but not limited to aquaria (warm, cold, fresh or salt water), garden ponds, carp pools, water gardens, large aquaria (zoos, public aquaria), and temporary containers for transporting fish.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure. In the following description, various embodiments of the present disclosure are described with reference to the following drawings, in which:

FIG. 1A and FIG. 1B show the analytical results of untreated aquarium water as control in the experimental study described in the Example section. FIG. 1A shows the weekly measurement of KH value and the nitrate concentration of the control. FIG. 1B shows the weekly measurement of the phosphate concentration and the soluble iron concentration.

FIG. 2A and FIG. 2B show the analytical results of Example 1 composition and methods of use in the experimental study described in the Example section. FIG. 2A shows the weekly measurement of KH value and the nitrate concentration of Example 1. FIG. 2B shows the weekly measurement of the phosphate concentration and the soluble iron concentration of Example 1.

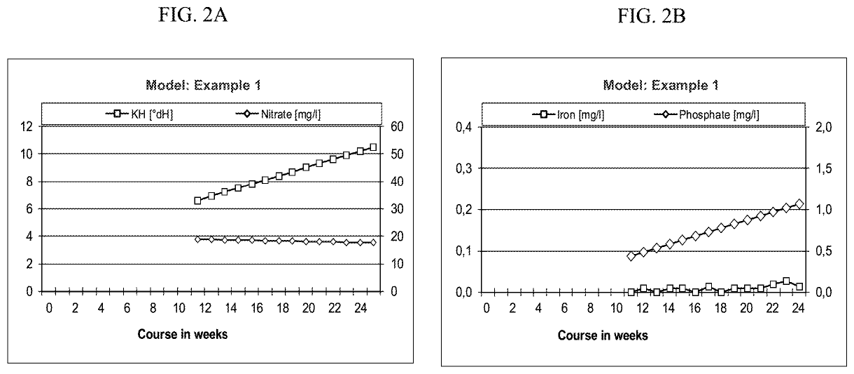

FIG. 3A and FIG. 3B show the analytical results of Example 2 composition and methods of use in the experimental study described in the Example section. FIG. 3A shows the weekly measurement of KH value and the nitrate concentration of Example 2. FIG. 3B shows the weekly measurement of the phosphate concentration and the soluble iron concentration of Example 2.

FIG. 4A and FIG. 4B show the analytical results of Example 3 composition and methods of use in the experimental study described in the Example section. FIG. 4A shows the weekly measurement of KH value and the nitrate concentration of Example 3. FIG. 4B shows the weekly measurement of the phosphate concentration and the soluble iron concentration of Example 3.

FIG. 5A and FIG. 5B show the analytical results of Example 4 composition and methods of use in the experimental study described in the Example section. FIG. 5A shows the weekly measurement of KH value and the nitrate concentration of Example 4. FIG. 5B shows the weekly measurement of the phosphate concentration and the soluble iron concentration of Example 4.

### DETAILED DESCRIPTION

Agents for Reducing and/or Removing Inorganic Nitrogen and Phosphorus

In some embodiments, the present disclosure relates to a composition for treating aquarium water comprising a first formulation for reducing or removing inorganic nitrogen and/or inorganic phosphorus in aquarium water; and a buffer.

Inorganic nitrogen unlimitedly encompasses gaseous NO, N₂O, NO₂, NO₃, nitrate, nitrite, ammonia, and ammonium in aquarium water. Inorganic phosphorus unlimitedly encompasses phosphoric acid and any possible conjugate anion thereof. The phosphate or orthophosphate ion PO₄³⁻ is derived from phosphoric acid by the removal of three protons H⁺. Removal of one or two protons gives the dihydrogen phosphate ion H₂PO₄⁻ and the hydrogen phosphate ion HPO₄²⁻ ion, respectively. Inorganic phosphorus can also be condensed phosphate in a form of pyrophosphates.

Inorganic nitrogen in aquarium water can be removed by inducing bacterial growth by adding a hydrogen-carbon source such as sugar, acetic acid. Especially under hypoxic conditions in the presence of inadequate levels of oxygen, the bacteria will rapidly consume NO₃⁻ and degrade this into N₂ and CO₂, which release out of aquarium water.

Because the formation of nitrate by nitrification occurs almost continuously in aquarium water, it is expedient to also allow the denitrification to take place continuously. The amount of nitrate being added daily in only a low concentration also makes it possible to omit large substance conversions during denitrification. Therefore, biologically degradable organic polymers having relatively low solubility are well suited as slowly reacting hydro-carbon sources.

In some embodiments, the first formulation of the composition comprises a biodegradable polyester. The biodegradable polyester can be either natural or synthetic polymer, including but not limited to polyhydroxyalkanoates (PHA), polyhydroxy butyrate (PHB), poly(3-hydroxybutyrate-co-3- hydroxyvalerate (PHBV), polylactic acid, poly(lactic-co-glycolic acid) (PLG), a polyhydroxy alkanoate-type polymer (PHAK), and poly(3-hydroxypropionic acid) (P(3-HP)). In addition to its slow solubilization in aqueous media, biodegradable polyesters are also environmentally friendly, and due to their biodegradable nature can gradually degrade into non-toxic low molecular weight species in aquarium water over time, causing little-to-no negative effect.

In preferred embodiments, the first formulation comprises polycaprolactone (PCL). PCL is found to be exceptionally functional in removing inorganic nitrogen, has considerable commercial availability, and is both manufacture- and cost-effective.

In some embodiments, the PCL of the first formulation is in a fine granular form. When using granulated PCL material, it was surprisingly found that nitrate reduction could be considerably more effective under aerobic operating conditions. In certain embodiments, the granular PCL has an average particle size of 1 mm or less.

In some embodiments, the first formulation comprises a metal carboxylate. In particular, the metal carboxylate may be a sparingly soluble salt of an organic carboxylic acid, wherein, the metal of the metal carboxylate includes but is not limited to Na⁺, K⁺, Al³⁺, Fe³⁺, La³⁺, TiO²⁺, ZrO²⁺, Cu²⁺, Zn²⁺, Ca²⁺, Mg²⁺, or Li⁺. The soluble metal cations from the metal carboxylate could lower or remove phosphate anions in aquarium water by forming exceptionally insoluble metal phosphate precipitates or metal hydroxides with co-flocculated phosphates. In preferred embodiments, metal carboxylate comprising at least one metal selected from the group consisting of Na⁺, K⁺, Al³⁺, La³⁺, Fe³⁺, TiO²⁺, ZrO²⁺, Ca²⁺, Cu²⁺, Zn²⁺, Mg²⁺, Li⁺, and combinations thereof.

The phosphate precipitation derived from the composition of the present disclosure is surprisingly advantageous because it produces no turbidity and/or flock formation in aquarium water and takes effect substantially and compatibly in the biologically active filter system. The metal carboxylates are toxicologically neutral, ecologically neutral, and do not affect carbonate hardness.

The carboxylic acid forming the metal carboxylate of the first formulation are generally aliphatic carboxylic acid, including but not limited to acetic acid, lactic acid, citric acid, tartaric acid, formic acid, propionic acid, malic acid, and the like.

In preferred embodiments, the metal carboxylate comprises at least one salt selected from the group consisting of Fe(III) citrate, Al(III) citrate, and the combinations thereof. Fe(III) citrate and Al(III) citrate are low cost agents, which could undergo aerobic decomposition in aquarium water to effectively release free Fe³⁺/Al³⁺ ions and/or Fe(OH)₃/Al(OH)₃ flocculants, all of which could bind to and precipitate out phosphates.

In other embodiments, the first formulation of the composition comprises an inorganic salt such as metal sulfates or metal chlorides, for example, Fe(II) sulfate. The inorganic salt may provide metal ions as the source for the metal carboxylate in the composition.

In some embodiments, the first formulation of the composition further comprises metal carboxylate and extra carboxylic acid(s). The extra carboxylic acid(s) may help increase the solubility of the metal carboxylates in aquarium water, thereby improving the efficiency of phosphate removal. The extra carboxylic acid(s) include but are not limited to acetic acid, lactic acid, citric acid, tartaric acid, formic acid, propionic acid, malic acid and the like.

Buffer

In some embodiments, the composition of the present disclosure comprises a buffer. One important function of the buffer is to stabilize the buffer capacity and maintain balance for acid-base balance, carbonate hardness, and alkalinity of aquarium water.

The acid-base balance is generally reflected by pH value. Carbonate hardness is a measure of the water hardness caused by the presence of carbonate (CO₃²⁻) and bicarbonate (HCO₃⁻) anions. Carbonate hardness is usually expressed either in degrees KH (° KH) (from the German “Karbonathärte”), or ppm calcium carbonate (ppm CaCO₃ or grams CaCO₃ per liter, mg/L). One ° KH is equal to 17.848 mg/L (ppm) CaCO₃, e.g. one ° KH corresponds to the carbonate and bicarbonate ions found in a solution of approximately 17.848 milligrams of calcium carbonate (CaCO₃) per liter of water (17.848 ppm). Both measurements (mg/L or ° KH) are usually expressed as mg/L CaCO₃, meaning the concentration of carbonate expressed as if calcium carbonate were the sole source of carbonate ions.

Alkalinity roughly refers to the total amount of base(s) in a solution that can be converted to uncharged species by a strong acid. Alkalinity reflects the capacity of water to resist changes in pH that would make the water more acidic. Because generally all anions except HCO₃⁻ and CO₃²⁻ have low concentrations, carbonate alkalinity, which is equal to the total anion concentration of HCO₃⁻ and CO₃²⁻, is also approximately equal to the total alkalinity. Alkalinity is usually measured by titrating the solution with a monoprotic acid such as HCl until its pH changes abruptly, or it reaches a known endpoint where that happens. Alkalinity is expressed in units of meq/L (milliequivalents per liter), which corresponds to the amount of monoprotic acid added as a titrant in millimoles per liter.

In aquarium water, the continuous oxidation of organic ammonia derived from food supplies or other protein sources continuously produces nitrite and free proton, H⁺. The liberated H⁺ reacts with bases present, neutralizes HCO₃⁻ and CO₃²⁻, and thereby causing a reduction of both the carbonate hardness and the alkalinity of the aquarium water if not effectively treated. Importantly, the neutralization of HCO₃⁻ and CO₃²⁻ may generate excess CO₂ that can lead to a rapid CO₂ damaging of the beneficial organism. Significant reduction of HCO₃⁻ can also causes loss of Ca(HCO₃)₂ which is more soluble in water, and consequently, the reduction of carbonate hardness.

The buffer of the present composition can advantageously resist pH change upon the generation of H⁺ from the oxidation process in aquarium water. The buffer is also able to neutralize small amounts of other added acid or bases, thus maintaining the pH of the solution relatively stable. The buffer according to the present disclosure generally consists of a weak conjugate acid-base pair, meaning either a. a weak acid and its conjugate base, or b. a weak base and its conjugate acid. The use of one or the other will simply depend upon the desired pH when preparing the buffer. The existence of effective amount of buffer in aquarium water help stabilize the desired pH value for a long period time without impairing other important functions.

In some embodiments, the buffer comprises water-soluble alkli metal carbonates or bicarbonates. For examples, Na₂CO₃, NaHCO₃, K₂CO₃, or KHCO₃. These buffers may function to cure the loss of HCO₃⁻ and CO₃²⁻ in aquarium water.

In preferred embodiments, the buffer of the present composition comprises one or more neutralized fruit acid(s). Neutralized acid generally means a conjugate acid-base pair. In some embodiments, the conjugate acid-base pair comprises one or more bases such as alkali metal, alkaline earth metal, ammonium, or the combinations thereof. The alkali metal encompasses lithium (Li), sodium (Na), potassium (K), rubidium (Rb), caesium (Cs), and francium (Fr). The alkaline earth metal generally encompasses beryllium (Be), magnesium (Mg), calcium (Ca), strontium (Sr), barium (Ba), and radium (Ra). The addition of alkali metal and alkaline metal from the neutralized fruit acid may further supplement the hardness of the aquarium water and function to maintain the carbonate hardness and alkalinity of the aquarium water.

The fruit acid forming the neutralized fruit acid according to the present disclosure includes but is not limited to alpha-hydroxyl carboxylic acids (AHAs), citric acid, glycolic acid, lactic acid, malic acid, tartaric acid and acetic acid. In certain non-limiting embodiments, the fruit acid is Multifruit BSC (Arch Chemicals), which is a mixture of lactic, citric, tartaric, glycolic, and malic acid extracted from plants. In other non-limiting embodiments of the present disclosure, the fruit acid is citric acid. A fruit acid for use in the present composition may be obtained from its natural source or may be chemically synthesized. Importantly, fruit acid(s) provide a stable source of hydrocarbon which can be precursors of HCO₃⁻ and CO₃²⁻, maintaining the carbonate hardness of aquarium water. As described herein, because fruit acids could undergo mild oxidation under aerobic condition in aquarium water, they could release HCO₃⁻ and CO₃²⁻ progressively and continuously, without a sudden change or increase of the carbonate concentration and alkalinity.

Metal Chelating Agents

In some embodiments, the composition of the present disclosure further comprises one or more metal chelating agent. Chelating agents are chemical compounds that react with metal ions to form a stable, water-soluble complex. They are also known as chelants, chelators, or sequestering agents. For example, monodentate ligand is a ligand that has only one atom that coordinates directly to the central atom in a complex. For example, ammonia and chloride ion are monodentate ligands of copper in the complexes [Cu(NH₃)₆]²⁺ and [CuCl₆]²⁺. Monodentate ligands usually have low to moderate binding affinity and are selectively functional to specific metal ions.

Most chelating agents, however, are polydentate ligands, having a ring-like center, which forms at least two coordination bonds with the central metal ion allowing it to be excreted. Importantly, the chelate effect is the enhanced affinity of polydentate chelating agent for a metal ion compared to the affinity of a collection of similar nonchelating ligands for the same metal.

For example, a neutralized amino acid having one chelating unit comprising an amino group and a neutralized carboxylate anion group can be a bidendate chelating agent because both the amino group contributing a pair of electrons and the carboxylate anion can chelate the metal cation via two coordinate bonds to form a ring-like complex structure. In some embodiments, the chelating agent of the present disclosure is a bidendate ligand, comprising one chelating unit. Exemplary bidentate ligand includes but not limited to amino acids such as glycine, diamines such as ethylenediammine or phenanthroline, bifunctional carboxylic acids such as oxalate, acetylacetonate and so on.

Other chelating agents are polydentates comprising three or more coordinating groups. For example, tridentate ligands such as terpyridine bind with three atoms. Tetradentate ligands bind with four donor atoms, an example being triethylenetetramine. Many naturally occurring macrocyclic ligands are tetradentative, an example being the porphyrin in heme. Pentadentate ligands bind with five atoms, an example being ethylenediaminetriacetic acid. Hexadentate ligands bind with six atoms, an example being ethylenediaminetetraacetic acid (EDTA). Ligands of denticity greater than 6 can also be used. The ligands 1,4,7,10-tetraazacyclododecane-1,4,7,10-tetraacetate (DOTA) and diethylene triamine pentaacetate (DTPA) are octadentate. They are particularly useful for binding heavy metal ions, which typically have coordination numbers greater than 6. Other polydentate chelating agents include EDDHA (ethylenediamine dihydroxyphenylacetic acid), HBED (N,N′-di(2-hydroxybenzyl)ethylenediamine-N, N′-diacetic acid), or other analogues of poly-functional N-amino-alkyl carboxylic acid. In general, the stability of a metal complex correlates with the denticity of the ligands, which can be attributed to the chelate effect. Polydentate ligands such as hexa- or octadentate ligands tend to bind metal ions more strongly than ligands of lower denticity, primarily due to entropic factors. Stability constants are a quantitative measure to assess the thermodynamic stability of coordination complexes.

The inventors discovered that the combination of chelating agent with metal carboxylate in the composition with appropriate concentrations thereof could significantly improve the efficiency of phosphate elimination in aquarium water. While not wishing to be bound to theory, it is believed that the chelating agent substantially improves the solubility of metal ions such as Na⁺, K⁺, Al³⁺, Fe³⁺, TiO²⁺, ZrO²⁺, Cu²⁺, Zn²⁺, Ca²⁺, Mg²⁺, or Li⁺, and increased the concentration of free metal ions, which precipitate unfavorable phosphate out of aquarium water.

In some embodiments, the chelating agent of the present composition comprises two or more chelating units, wherein the chelating unit is N(CH(R¹)R²COOH) or conjugate anion thereof, wherein R¹ is H or alkyl group, and R² is absent or an alkyl group. An example of such chelating agent is EDTA, which comprising four N(CH₂COOH) groups.

In some embodiments, the metal chelating agent of the present composition comprises EDTA or conjugate anion thereof, which is a highly efficient and economic chelating agent producing stable complex with various metal ions. The metal-EDTA has a general structure:

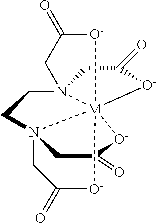

In some embodiments, the present composition comprises iron citrate in the first formulation, and EDTA as the metal chelating unit. It is surprisingly found that EDTA unexpectedly improves the efficiency in removing phosphate, constantly maintaining the phosphate concentration below about 2 mg/L, which effectively retards algae growth. While not wishing to be bound to theory, it is believed that EDTA facilitates the solublization of iron citrate, releasing free iron ions into aquarium water, and promote the reaction of iron with phosphate, forming iron phosphate analogues having poor solubility or co-flocculants Fe(OH)₃-phosphate precipitates, which could be later filter out.

In some embodiments, the metal chelating agent of the present composition further comprises one or more ion such as Na⁺, K⁺, Fe³⁺, or Al³⁺, or combination thereof. For example, the metal chelating agent can be Fe(III)-EDTA, which provides additional iron source to aquarium water, further improving phosphate elimination. While not wishing to be bound to a particular theory, it is important to note that although citrate having multiple carboxylate groups in one molecule may also have chelate effect, citrate tends to be naturally decomposed by bacteria within 1-2 days in the aquarium water, and thus not as efficient as the chelating agents having N-amino alkyl carboxylate groups, or N(CH(R¹)R²COOH), wherein R¹ is H or alkyl group, and R² is absent or an alkyl group. In some embodiments, the metal chelating agent of the present composition comprises pentetic acid or conjugate anion thereof. Pentetic acid, or diethylenetriaminepentaacetic acid (DTPA) is an aminopolycarboxylic acid consisting of a diethylenetriamine backbone with five carboxymethyl groups. DTPA can be viewed as an expanded version of EDTA and is used similarly. The conjugate base of DTPA has an ultra-high affinity for metal cations. The penta-anion DTPA⁵⁻ can be an octadentate ligand assuming that each nitrogen center and each CO₃²⁻ group counts as a center for coordination. The formation constants for its complexes are about 100 greater than those for EDTA. As a chelating agent, DTPA wraps around a metal ion by forming up to eight bonds. Its complexes can also have an extra water molecule that coordinates the metal ion. Because of many coordinating groups in DTPA, after forming a complex with a metal, DTPA still has the ability to bind to other reagents by its derivative pendetide. For example, in its complex with Ca²⁺, DTPA binds in a hexadentate manner utilizing the three amine centers and three of the five carboxylates. The general structure of metal DTPA complex is:

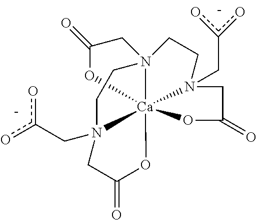

In other embodiments, the metal chelating agent of the present composition comprises methylglycinediacetic acid (MGDA) or conjugate anion thereof. Methylglycinediacetic acid, or N-(1-carboxylatoethyl)iminodiacetic acid, or α-DL-alanine diacetic acid is a tetradentate chelating and complexing agent, comprising three N(CH(R¹)R²COOH) or conjugate anion thereof, wherein R¹ is H or alkyl group, and R² is absent or an alkyl group. MGDA or salts thereof such as sodium methylglycinediacetate may be in granular form, for example, as Trilon M powder (CAS #: 164462-16-2). MGDA has the similar function as EDTA. It is surprisingly found that composition comprising MGDA as the metal chelating agent applied to aquarium water could also constantly maintain the phosphate concentration thereof below about 1 mg/L. The structure of MGDA is:

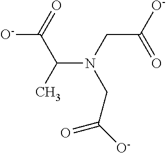

In some embodiments, the metal chelating agent of the present composition comprises glutamic acid di-acetic acid or conjugate anion thereof. Glutamic acid di-acetic acid (GLDA, CAS #: 51981-21-6) or the sodium salts thereof has four N(CH(R¹)R²COOH) units, wherein R¹ is H or alkyl group, and R² is absent or an alkyl group, and also provides high affinity to metal ions in a way like MGDA. The structure of GLDA is below:

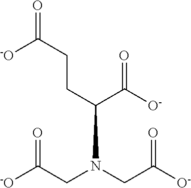

In some embodiments, the metal chelating agent of the present composition comprises iminodisuccinic acid analogues or conjugate anions thereof. Iminodisuccinic acid (IDS) or N-(1,2-dicarboxyethyl)aspartic acid comprises two N(CHRCOOH) groups and two N(CHRCH₂COOH) groups, providing five coordinating sites to metal ions. Tetrasodium salts of IDS can be in forms of either powder (such as Baypure® CX 100) or as granular material with more than 75% purity. Tetrasodium salts of IDS functioning as a pentadentate ligand forms metal complexes of moderate stability, which includes alkaline earth and polyvalent heavy metal ions with one molecule of water in an octahedral structure. The structure of IDS is below:

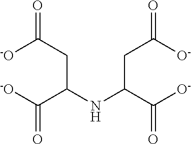

In other embodiments, the metal chelating agent of the present disclosure is ethylenediamine-N,N′-disuccinic acid (EDDS) or conjugate anion thereof. EDDS is similar to IDS but has two amino groups and four carboxylate groups. EDDS is also a functional analogue to EDTA, having high binding affinity and chelation efficiency with various metal ions. The structure of EDDS is below:

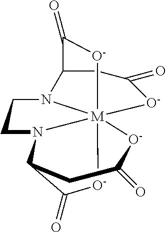

In some embodiments, the chelating agents of the present composition is degradable or biodegradable in aquarium water. For example. Certain chelating agents such as MGDA, GDLA, IDS, and EDDS readily biodegradable chelating agent and ecofriendly, providing additional advantage to the aquarium water treatment.

In some embodiments, the present composition comprises at least two chelating agents. As an exemplary example, the present composition comprises Fe(III)-EDTA and MGDA.

Botanical Oil

In some embodiments, the present composition further comprises a botanical oil.

Botanical oils, or essential oils, are a concentrated hydrophobic liquid containing volatile chemical compounds from plants. Essential oils are also known as volatile oils, ethereal oils, aetherolea, or simply as the oil of the plant from which they were extracted. Essential oils are widely used in bodycare products. For example, essential oils can increases elasticity of skin, which makes it a valuable component of anti-aging treatments or for mature skin. Essential oils also help to maintain hydration levels in the tissues, and help other beneficial ingredients penetrate the body more effectively. Essential oils can also cure the injuries or diseases of aquatic animals, improving their activity and vitality. Examples of botanical oils include but are not limited to argan oil from Argania spinose; evening primrose oil from Oenothera biennis; tea tree oil from Melaleuca; eucalyptus oil from Eucalyptus globulus; almond oil from Prunus amygdalus dulcis or Prunus armeniaca; grapeseed oil from Vitis vinifera; rosehip oil from Rosa canina; lavender oil from Lavandula angustifolia; lemongrass oil from Cymbopogon flexuosus; or German chamomile oil from Matricaria recutita.

In some embodiments, the present composition comprises tea tree oil or extracts thereof. Tea tree oil derived from natural tea tree plants has exceptional antibacterial, anti-inflammatory, antifungal, antiviral, and antimicrobial properties. Tea tree oils are widely used in skincare products, providing excellent benefits in treating acne, athlete's foot, contact dermatitis, dandruff and cradle cap, head lice, and others.

As a non-limiting example, the tea tree oil of the present composition is cajeput. As used herein, cajeput or cajuput or cajeputi or cajeputol or oil of tram, is the substance that is obtainable from the low growing shrub-like tree of the Melaleuca species, such as Melaleuca cajuputi Powell (Myrtaceae) or Melaleuca leucadendron L. (Myrtaceae), which are indigenous to southeast Asia. Cajeput oil is typically produced by the technique of hydrodistillation (steam distillation) of fresh leaves and twigs of the Melaleuca species. It is important to note that the tea tree oil or cajeput of the present disclosure is a complex mixture of components normally found in cajeput oil, rather than a single component fractionally distilled and separated from cajeput, e.g., eucalyptol or 1,8-cineole. Cajeput oil is produced in commercial quantities in Southeast Asia, and is readily available from commercial suppliers of naturally derived food and cosmetic oils and extracts.

In some embodiments, the present composition comprise a second formulation, wherein the second formulation consists essentially of a tea tree oil or extract, a solvent, and a co-emulsifier. The solvent and the co-emulsifier from the second formulation can facilitate the dissolution and stabilization of the teat tree oil in the composition. The solvent can be a common solvent, including but not limited to water, glycerol, 1,2-propylene glycol, propylene glycol, dipropylene glycol, hexylene glycol, or combinations thereof. The co-emulsifier can be a commonly used stabilizing agent including but not limited to cornstarch, cellulose, carboxymethyl cellulose (CMC), pre-gelatinized starch, arrowroot, agar-agar, carrageenan, gum arabic or acacin, gum tragacanth, and pectin. In preferred embodiments, the second formulation consists essentially of tea tree oil, 1,2-propylene glycol, and carrageenan.

In practice, the second formulation can be prepared by mixing the tea tree oil with the solvent and the co-emulsifier and water to form a stable and homogenous solution. The second formulation can then be combined with other components to form the present composition, which ultimately comprises tea tree oil.

Due to the hydrophobic nature of tea tree oil or cajeput oil, it may form oil-in-water emulsion when added to aquarium water. While not wishing to be bound by a particular theory, the tea tree oil in water emulsion may protect the hydrocarbon structure of effective components in the tea tree oil from being oxidized too quickly, and may help extend the efficacy of the beneficial use of the effective components in treating aquarium water.

In some embodiments, the present composition comprises both a metal chelating agent and a tea tree oil. It is surprisingly found that the tea tree oil and the metal chelating agent could compatibly and synergistically improve the effectiveness of water treatment, without impairing the total efficiency.

Other Useful Agents

The present composition may optionally comprise other useful agents including but not limited to thickener, mineral concentration, vitamin concentrate (containing particular “B”-vitamin's), preservative such as potassium sorbate.

In the context of aquatic biology, a mineral is an element required as an essential nutrient by organisms to perform functions necessary for life. The mineral concentrate used in the present disclosure may comprise nutrients such as potassium, sodium, magnesium, and trace elements. The trace elements that have a specific biochemical function are sulfur, iron, chlorine, cobalt, copper, zinc, manganese, molybdenum, iodine, and selenium.

A thickening agent or thickener is a substance, which can increase the viscosity of a liquid without substantially changing its other properties. In particular, the thickener used in the present composition may increase the viscosity thereof and to prevent the sedimentation of the biodegradable polyester fine particles. Thickeners used in the present composition include but are not limited to cornstarch, cellulose, carboxymethyl cellulose (CMC), pre-gelatinized starch, arrowroot, agar-agar, carrageenan, gum arabic or acacin, gum tragacanth, xanthan gum, and pectin.

A Vitamin Concentrate used in the present composition encompasses a large number of vitamins, including but not limited to Vitamins K, C, B2, B1, B6, and B12; niacinamide; dexpanthenol; biotin; and folic acid. In preferred embodiments, the Vitamin Concentrate consists essentially of water-soluble vitamins.

As an exemplary example, the formulation of the vitamin concentrated used in the present composition is shown in Table 1.

TABLE 1
An exemplary example of vitamin concentrate
used in the present composition.

| Component | Unit (g) |
|---|---|
| Vitamin B1 | 4.00 |
| Nicotinamide (a form of Vitamin B3) | 1.20 |
| Panthenol (a form of Vitamin B5) | 0.52 |
| Vitamin B2 | 0.24 |
| Vitamin B6 | 0.12 |
| Butrol 1060 as a preservative | 1.00 |

A mineral concentrate used in the present composition encompasses a large number of minerals, including but not limited to Fe or salts thereof, Mn or salts thereof, Zn or salts thereof, K or salts thereof, Cu or salts thereof, Boron or derivatives thereof, chloride, sulfate, iodide, bromide. An exemplary example of the mineral concentrate is shown in Table 2.

TABLE 2
An exemplary example of the mineral concentrate
used in the present composition.

| | Weight Percentage |
|---|---|
| Component of mineral concentrate | (g/L) |
| Iron chloride•6 H₂O | 24.2 |
| Manganese chloride•4 H₂O | 4.24 |
| Zinc sulfate•7 H₂O | 2.58 |
| Boric acid | 2.24 |
| Potassium bromide | 0.58 |
| Potassium iodide | 0.53 |
| Copper sulfate•5 H₂O | 0.40 |
| Magnesium chloride•6 H₂O | 0.14 |
| Potassium sorbate as a preservative | 2.00 |

A preservative is a substance or a chemical that is added to prevent decomposition by microbial growth or by undesirable chemical changes. Preservative additives of the present disclosure could reduce the risk of infections, decrease microbial spoilage, and preserve fresh attributes and nutritional quality to fish and other inhabitants of the aquarium. As non-limiting examples, the preservative of the present composition may be potassium sorbate, or Butrol 1060.

Aqueous Composition

In some embodiments, the present disclosure relates to an aqueous composition for treating aquarium water comprising: a first formulation for reducing or removing inorganic nitrogen and/or inorganic phosphorus in aquarium water; a buffer; and water. In some embodiments, the aqueous composition further comprises one or more metal chelating agent. In other embodiments, the aqueous composition further comprises a tea tree oil of extract thereof.

In some embodiments, the present disclosure relates to an aqueous composition for treating aquarium water comprising a first formulation, a buffer, one or more metal chelating agent, and water. In related embodiments, the first formulation may comprise a first agent and a second agent, wherein the first agent comprises a biodegradable polyester, wherein the first agent is from about 0.1 wt % to about 10 wt %, or from about 0.5 wt % to about 8 wt %, from about 1 wt % to about 6 wt %, or from about 1 wt % to about 4 wt %; a second agent; wherein the second agent comprises a metal carboxylate, wherein the second agent is about 0.01 wt % to about 5 wt %, or from about 0.05 wt % to about 4 wt %, or from about 0.1 wt % to about 3 wt %, or from about 0.2 wt % to about 2 wt %, or from about 0.3 wt % to about 1 wt %, or from about 0.4 wt % to about 1 wt %. In other related embodiments the buffer comprises one or more neutralized fruit acid(s), wherein the buffer is from about 0.1 wt % to about 20 wt %, or from about 0.5 wt % to about 15 wt %, or from about 1 wt % to about 10 wt %, or from about 2 wt % to about 8 wt %, or from about 2.5 wt % to about 6 wt %. In some exemplary embodiments, the metal chelating agent comprises one or more N(CH(R¹)R²COOH) or conjugate anion thereof, wherein R¹ is H or alkyl group, and R² is absent or an alkyl group, and wherein the metal chelating agent is from about 0.001 wt % to about 1 wt %, or from about 0.005 wt % to about 0.5 wt %, or from about 0.01 wt % to about 0.15 wt %, or from about 0.01 wt % to about 0.1 wt %, or from about 0.02 wt % to about 0.05 wt %, wherein the wt % is based on the total weight of the composition.

In some embodiments, the metal chelating agent of the present composition further comprises an ion selected from Na⁺, K⁺, Fe³⁺, Al³⁺, or combination thereof. In some embodiments, the metal chelating agent comprises EDTA and MGDA, and/or conjugated anion thereof, and/or a metal ion such as Fe³⁺, or Al³⁺, or combination thereof.

In certain embodiments, the present aqueous composition comprises a tea tree oil or extract thereof, wherein the tea tree oil is from about 0.01 wt % to about 1 wt %, or from about 0.05 wt % to about 0.5 wt %, or from about 0.05 wt % to about 0.15 wt %, or from about 0.1 wt % to about 0.15 wt %, wherein the wt % is based on the total weight of the composition.

In certain embodiments, the present aqueous composition comprises a second formulation consisting essentially of a tea tree oil, a solvent, and a co-emulsifier, wherein the solvent is selected from the group consisting of water, glycerol, 1,2-propylene glycol, propylene glycol, dipropylene glycol, hexylene glycol, or combinations thereof, wherein the co-emulsifier is selected from the group of cornstarch, cellulose, carboxymethyl cellulose (CMC), pre-gelatinized starch, arrowroot, agar-agar, carrageenan, gum arabic or acacin, gum tragacanth, pectin, or combinations thereof. In some embodiments, the tea tree oil of the second formulation is from about 0.01 wt % to about 1 wt %, or from about 0.05 wt % to about 0.5 wt %, or from about 0.05 wt % to about 0.15 wt %, or from about 0.1 wt % to about 0.15 wt %, wherein the wt % is based on the total weight of the aqueous composition. In some embodiments, the solvent of the second formulation is from about 0.5 wt % to about 10 wt %, or from about 1 wt % to about 5 wt %, or from about 1 wt % to about 3 wt %, or from about 1 wt % to about 2 wt %, wherein the wt % is calculated based on the total weight of the aqueous composition. In certain embodiments, the second formulation consists essentially of tea tree oil, 1,2-propylene glycol, and carrageenan.

The second formulation can be prepared by mixing the tea tree oil with the solvent and the co-emulsifier and water to form a stable and homogenous solution. The second formulation can then be combined with other components to form the aqueous composition, which ultimately comprises tea tree oil. The solvent may function as a solubilizing/dispersing agent, assisting the dispersion and stabilization of tea tree oil into the aqueous composition and/or into the aquarium water.

In some embodiments, the present aqueous composition optionally comprises a thickener, wherein the thickener is selected from the group consisting of cornstarch, cellulose, carboxymethyl cellulose (CMC), pre-gelatinized starch, arrowroot, agar-agar, carrageenan, gum arabic or acacin, gum tragacanth, pectin, xanthan gum, or combination thereof. In some embodiments, the thickener is from about 0.05 wt % to about 1 wt %, or from about 0.1 wt % to about 0.5 wt %, or from about 0.2 wt % to about 0.5 wt %, or from about 0.2 wt % to about 0.4 wt %, or from about 0.2 wt % to about 0.3 wt %, wherein the wt % is calculated based on the total weight of the aqueous composition.

In some embodiments, the present aqueous composition optionally comprises a mineral concentrate, a vitamin concentrate, a preservative, or any combination thereof, wherein the mineral concentrate is from about 0.1 wt % to about 5 wt %, or from about 0.2 to about 4 wt %, or from about 0.3 to about 3 wt %, or from about 0.4 to about 2 wt %, or from about 0.5 to about 1 wt %, wherein the vitamin concentrate is from about 0.1 wt % to about 5 wt %, or from about 0.2 to about 4 wt %, or from about 0.3 to about 3 wt %, or from about 0.4 to about 2 wt %, or from about 0.5 to about 1 wt %, wherein the preservative is selected from potassium sorbate, Butrol 1060, or combination thereof, wherein the preservative is from about 0.05 wt % to about 1 wt %, or from about 0.1 wt % to about 0.5 wt %, from about 0.1 wt % to about 0.3 wt %, or from about 0.2 wt % to about 0.3 wt %, wherein the wt % is calculated based on the total weight of the aqueous composition.

As an exemplary example, the present aqueous composition comprises a first formulation, a buffer, one or more metal chelating agent, a second formulation, and water, wherein the first formulation comprises: a first agent comprising from about 1 wt % to about 4 wt % of a PCL in fine granular; and a second agent, wherein the second agent comprising from about 0.4 wt % to about 1 wt % of Fe(III) citrate, or Al(III) citrate, or combination thereof. In some related embodiments the buffer comprises from about 2.5 wt % to about 6 wt % of one or more neutralized fruit acid(s). In at least these embodiments, the metal chelating agent is selected from the group of EDTA or conjugate anion thereof, Fe(III)-EDTA, Al(III)-EDTA, MGDA conjugate anion thereof, Fe(III)-MGDA, Al(III)-MGDA, and combinations thereof, wherein the metal chelating is from about 0.01 wt % to about 0.15 wt %; and the second formulation comprises from about 0.05 wt % to about 0.25 wt % of a tea tree oil, from about 1 wt % to about 3 wt % of 1,2-propylene glycol, and from about 0.01 wt % to about 0.05 wt % of carrageenan, wherein the wt % is calculated based on the total weight of the composition.

As another exemplary example, the present aqueous composition comprises a first formulation, a buffer, one or more metal chelating agent, a second formulation, a thickener, a vitamin concentrate, a mineral concentrate, a preservative, and water, wherein the first formulation comprises: a first agent comprising from about 1 wt % to about 4 wt % of a PCL in fine granular; and a second agent, wherein the second agent comprising from about 0.4 wt % to about 1 wt % of a Fe(III) citrate, or a Al(III) citrate, or combination thereof. Further, the buffer comprises from about 2.5 wt % to about 6 wt % of one or more neutralized fruit acid(s) where the metal chelating agent is selected from the group of EDTA or conjugate anion thereof, Fe(III)-EDTA, Al(III)-EDTA, MGDA conjugate anion thereof, Fe(III)-MGDA, Al(III)-MGDA, and combinations thereof, where the metal chelating is from about 0.01 wt % to about 0.15 wt %; and where the second formulation comprises from about 0.05 wt % to about 0.25 wt % of a tea tree oil, from about 1 wt % to about 3 wt % of 1,2-propylene glycol, and from about 0.01 wt % to about 0.05 wt % of carrageenan. In related embodiments, the composition may comprise a thickener from about 0.2 wt % to about 0.4 wt %; a mineral concentrate is from about 0.2 wt % to about 2 wt %; a vitamin concentrate from about 0.2 wt % to about 2 wt %; and where the preservative is selected from the group of potassium sorbate, Butrol 1060, or combination thereof and has a content from about 0.1 wt % to about 0.5 wt %. In at least these example embodiments, the wt % is calculated based on the total weight of the composition.

Method of Use

In some embodiments, the present disclosure relates to a method of treating aquarium water comprising adding/applying a composition to aquarium water, wherein the composition comprises: a first formulation for reducing or removing inorganic nitrogen and/or inorganic phosphorus in aquarium water; and a buffer. In other embodiments, the composition used in the present method further comprises one or more metal chelating agent. In other embodiments, the composition used in the present method further comprises a tea tree oil or extract thereof.

In some embodiments, the present disclosure relates to a method of treating aquarium water comprising adding/applying a composition to aquarium water, wherein the composition comprises a first formulation, a buffer, one or more metal chelating agent, wherein the first formulation comprises: a first agent, wherein the first agent comprises a biodegradable polyester, wherein the first agent is from about 0.1 wt % to about 10 wt %, or from about 0.5 wt % to about 8 wt %, from about 1 wt % to about 6 wt %, or from about 1 wt % to about 4 wt %; a second agent, wherein the second agent comprises a metal carboxylate, wherein the second agent is from about 0.01 wt % to about 5 wt %, or from about 0.05 wt % to about 4 wt %, or from about 0.1 wt % to about 3 wt %, or from about 0.2 wt % to about 2 wt %, or from about 0.3 wt % to about 1 wt %, or from about 0.4 wt % to about 1 wt %. In at least these embodiments the buffer comprises one or more neutralized fruit acid(s), wherein the buffer is from about 0.1 wt % to about 20 wt %, or from about 0.5 wt % to about 15 wt %, or from about 1 wt % to about 10 wt %, or from about 2 wt % to about 8 wt %, or from about 2.5 wt % to about 6 wt %; and wherein the metal chelating agent comprises one or more N(CH(R¹)R²COOH) or conjugate anion thereof, wherein R¹ is H or alkyl group, and R² is absent or an alkyl group, and wherein the metal chelating agent is from about 0.001 wt % to about 1 wt %, or from about 0.005 wt % to about 0.5 wt %, or from about 0.01 wt % to about 0.15 wt %, or from about 0.01 wt % to about 0.1 wt %, or from about 0.02 wt % to about 0.05 wt %, wherein the wt % is calculated based on the total weight of the composition.

In some embodiments, the metal chelating agent of the composition used in the present method further comprises a metal ion such as Na⁺, K⁺, Fe³⁺, or Al³⁺, or combination thereof. In some embodiments, the metal chelating agent comprises EDTA and MGDA, and/or conjugated anion thereof, and/or a metal ion such as Fe³⁺, or Al³⁺, or combination thereof.

In some embodiments, the composition used in the present method further comprises a tea tree oil or extract, wherein the tea tree oil is from about 0.01 wt % to about 1 wt %, or from about 0.05 wt % to about 0.5 wt %, or from about 0.05 wt % to about 0.15 wt %, or from about 0.1 wt % to about 0.15 wt %, wherein the wt % is calculated based on the total weight of the aqueous composition.

In some embodiments, the composition used in the present method comprises a second formulation consisting essentially of a tea tree oil or extract, a solvent, and a co-emulsifier, wherein the solvent is selected from the group consisting of glycerol, 1,2-propylene glycol, propylene glycol, dipropylene glycol, hexylene glycol, or combinations thereof, wherein the co-emulsifier is selected from the group of cornstarch, cellulose, carboxymethyl cellulose (CMC), pre-gelatinized starch, arrowroot, agar-agar, carrageenan, gum arabic or acacin, gum tragacanth, pectin, or combinations thereof. In some embodiments, the tea tree oil of the second formulation is from about 0.01 wt % to about 1 wt %, or from about 0.05 wt % to about 0.5 wt %, or from about 0.05 wt % to about 0.15 wt %, or from about 0.1 wt % to about 0.15 wt %, wherein the wherein the wt % is based on the total weight of the aqueous composition. In some embodiments, the solvent of the second formulation is from about 0.5 wt % to about 10 wt %, or from about 1 wt % to about 5 wt %, or from about 1 wt % to about 3 wt %, or from about 1 wt % to about 2 wt %, wherein the wt % is calculated based on the total weight of the aqueous composition. In certain embodiments, the second formulation consists essentially of tea tree oil, 1,2-propylene glycol, and carrageenan.

As an exemplary example, the present method of treating aquarium water comprises adding/applying a composition to aquarium water, wherein the composition comprises a first formulation, a buffer, one or more metal chelating agent, and a second formulation. In these example embodiments the first formulation comprises: a first agent comprising from about 1 wt % to about 4% of a PCL fine granular; and a second agent, wherein the second agent comprising from about 0.4 wt % to about 1 wt % of a Fe(III) citrate, or a Al(III) citrate, or combination thereof. In these example embodiments, the buffer may comprise from about 2.5 wt % to about 6 wt % of one or more neutralized fruit acid(s). Still further, the composition may include a metal chelating agent selected from the group of EDTA or conjugate anion thereof, Fe(III)-EDTA, Al(III)-EDTA, MGDA or conjugate anion thereof, Fe(III)-MGDA, Al(III)-MGDA, and combinations thereof, wherein the metal chelating is from about 0.01 wt % to about 0.15 wt %; and wherein the second formulation comprises from about 0.05 wt % to about 0.25 wt % of a tea tree oil, from about 1 wt % to about 3 wt % of 1,2-propylene glycol, and from about 0.01 wt % to about 0.05 wt % of carrageenan, wherein the wt % is calculated based on the total weight of the composition.

As another exemplary example, the present method of treating aquarium water comprises adding/applying a composition to aquarium water, wherein the composition comprises a first formulation, a buffer, one or more metal chelating agent, a second formulation, a thickener, a vitamin concentrate, a mineral concentrate, a preservative, and water. The first formulation may comprise a first agent comprising from about 1 wt % to about 4 wt % of a PCL in fine granular; and a second agent, wherein the second agent comprising from about 0.4 wt % to about 1 wt % of a Fe(III) citrate, or a Al(III) citrate, or combination thereof. Still further, the buffer may comprise from about 2.5 wt % to about 6 wt % of one or more neutralized fruit acid(s). In other related embodiments, the metal chelating agent is selected from the group of EDTA or conjugate anion thereof, Fe(III)-EDTA, Al(III)-EDTA, MGDA conjugate anion thereof, Fe(III)-MGDA, Al(III)-MGDA, and combinations thereof, wherein the metal chelating is from about 0.01 wt % to about 0.15 wt %. Moreover, the second formulation comprises from about 0.05 wt % to about 0.25 wt % of a tea tree oil, from about 1 wt % to about 3 wt % of 1,2-propylene glycol, and from about 0.01 wt % to about 0.05 wt % of carrageenan, the thickener is from about 0.2 wt % to about 0.4 wt %; the mineral concentrate is from about 0.2 wt % to about 2 wt %; the vitamin concentrate is from about 0.2 wt % to about 2 wt %; the preservative is selected from the group of potassium sorbate, Butrol 1060, or combination thereof and has a content from about 0.1 wt % to about 0.5 wt %. In at least these example embodiments, the wt % is calculated based on the total weight of the composition.

In some embodiments, the present method of treating aquarium water comprises adding/applying an aqueous composition into aquarium water, wherein the total amount of the aqueous composition per month is from about 50 mL to about 200 mL per 100 L of aquarium water, or from about 50 mL to about 100 mL per 100 L of aquarium water, or from about 100 mL to about 150 mL per 100 L of aquarium water, or from about 100 mL to about 200 mL per 100 L of aquarium water. In certain embodiments, the present method comprises adding an aqueous composition into aquarium water at least once per month, wherein the total amount of the aqueous composition is from about 100 mL to about 200 mL per 100 L of aquarium water, and wherein the aqueous composition comprises from about 1 wt % to about 4 wt % of a biodegradable polyester; from about 0.4 wt % to about 1 wt % of a metal carboxylate; from about 2.5 wt % to about 6 wt % of a buffer; from about 0.02 wt % to about 0.05 wt % of a metal chelating agent; and optionally from about 0.05 wt % to about 0.15 wt % of a tea tree oil of extract thereof, wherein the wt % is calculated based on the total weight of the aqueous composition. In practicing the present methods, a person having ordinary skill in the art will be capable of calculating the dosage and frequency based on the total amount of the composition required to use.

In some embodiments, the present method comprises adding/applying the composition into aquarium water at a frequency of once per month. In other embodiments, the present method comprises adding the composition into aquarium water at a frequency of twice per month (equivalent to a biweekly interval between two application in a month), or three times per month, or four times per month (equivalent to a weekly interval between two successive applications in a month).

One particular advantage of the present method is the reduction of frequency or the number of times of application of water treatment composition per month. Traditional water treatment compositions are typically applied more than once per week. If the application cycles of traditional compositions are extended, for example, from every week to every two weeks or a month, a reduced performance will result including fluctuating water parameters, a decrease in the buffer capacity, and an unfavorable increase of nitrate and phosphate. The method according to the present disclosure allows for application of the present water treatment compositions in a frequency from once per week to once per month without changing aquarium water over a long period up to several months, which may conveniently benefit aquarium owner and significantly improve the efficiency of water treatment.

In some embodiments, the present method comprises adding/applying an effective amount of the present composition comprising a metal chelating agent, wherein method operatively enables the treated aquarium water to have a stable concentration of chelating agent from about 0.01 mg/L to about 0.5 mg/L, or from about 0.01 mg/L to about 0.3 mg/L per month, or from about 0.02 mg/L to about 0.5 mg/L per month, or from about 0.02 mg/L to about 0.25 mg/L per month, or from about 0.02 mg/L to about 0.15 mg/L per month, or from about 0.05 mg/L to about 0.25 mg/L per month, or from about 0.05 mg/L to about 0.15 mg/L per month, or from about 0.1 mg/L to about 0.2 mg/L per month. In other embodiments, the present method operatively enables the treated aquarium water to have a stable concentration of soluble metal ions from about 0.01 mg/L to about 0.5 mg/L per month, or from about 0.01 mg/L to about 0.3 mg/L per month, or from about 0.02 mg/L to about 0.5 mg/L per month, or from about 0.02 mg/L to about 0.25 mg/L per month, or from about 0.02 mg/L to about 0.15 mg/L per month, or from about 0.05 mg/L to about 0.25 mg/L per month, or from about 0.05 mg/L to about 0.15 mg/L per month, or from about 0.1 mg/L to about 0.2 mg/L per month. In certain embodiments, the metal ion comprises Fe′. In some embodiments, the present method operatively enables aquarium water to have a phosphate concentration of less than about 2 mg/L for at least about 14 weeks. In some embodiments, the present method operatively enables aquarium water to have a nitrate concentration of less than about 25 mg/L for at least about 14 weeks. The stable and constant presence of soluble metal ion and/or chelating agent in aquarium unexpectedly suppresses phosphate, maintaining a concentration of phosphate ultralow, constantly less than about 1 mg/L for at least 14 weeks after application.

### Examples

Certain embodiments of the present disclosure are further described with reference to the following examples. These examples are intended to be merely illustrative of the disclosure and are not intended to limit or restrict the scope of the present disclosure in any way and should not be construed as providing conditions, parameters, reagents, or starting materials that must be utilized exclusively in order to practice the art of the present disclosure.

Four examples of the present composition for treating aquarium water were prepared according to Table 1. All four examples are aqueous compositions. Water treatment application and analysis of variants were performed by experimental studies as follows: each of the four example compositions was applied to a pre-stabilized aquarium tank comprising 100 L of aquarium water, wherein the tank was planted and stocked with fish. The application of composition was finished in one month. The treated aquarium tanks were allowed to settle for six more weeks to allow the compositions to take effect. A control was included without adding any water treatment composition. Sodium bicarbonate (3×) was added to the control to prevent the KH value from being too low. Four parameters were analyzed weekly and monitored from the 11^{th} week to the 25^{th} week, including the hardness KH (° dH), the nitrate concentration (mg/L), the phosphate concentration (mg/L), and the iron concentration (mg/L).

TABLE 1
Compositions of Examples 1-4.

| | Example 1 | | Example 2 | | Example 3 | | Example 4 | |
|---|---|---|---|---|---|---|---|---|
| Components | Amount | Unit | Amount | Unit | Amount | Unit | Amount | Unit |
| Thickener | 2.60 | g | 2.60 | g | 2.60 | g | 2.60 | g |
| PCL (fine granule) | 40.00 | g | 20.00 | g | 40.00 | g | 40.00 | g |
| Neutralized fruit acids | 56.45 | g | 25.60 | g | 28.23 | g | 28.23 | g |
| Fe(III)-Citrate | 10.00 | g | 4.25 | g | 5.00 | g | 5.00 | g |
| Mineral concentrate | 10.00 | ml | 5.00 | ml | 10.00 | ml | 10.00 | ml |
| Vitamin concentrate | 10.00 | ml | 5.00 | ml | 10.00 | ml | 10.00 | ml |
| Potassium Sorbate | 2.00 | g | 2.00 | g | 2.00 | g | 2.00 | g |
| Fe(III)-EDTA | | | 0.2-1.2 | g | | | | |
| Trilon M powder | | | | g | | | 0.49 | g |
| (CAS164462-16-2) | | | | | | | | |
| Tea tree oil (Cajepute oil) | | | 1.25 | g | | | | |
| 1,2 Propylene glycol | | | 13.00 | g | | | | |
| Carrageenan | | | 0.25 | g | | | | |
| Deionized water (rest to 1 L) | ca. 870 | ml | ca. 918 | ml | ca. 900 | ml | ca. 900 | ml |
| dosage per 100 L: | 25 | ml | 50 | ml | 100 | ml | 100 | ml |
| frequency per month: | 4 | | 4 | | 1 | | 1 | |
| ml-addition per month: | 100 | ml | 200 | ml | 100 | ml | 100 | ml |

| addition of PCL per month: | for all Examples identical | |
|---|---|---|
| addition of fruit acids per month: | comparable to Example 1 | approximately 50% of Example 1 |
| addition of minerals & | for all Examples identical | |
| vitamins per month: | | |
| addition of | comparable to Example 1 | approximately 50% of Example 1 |
| iron(III)citrate | | |
| per month: | | |

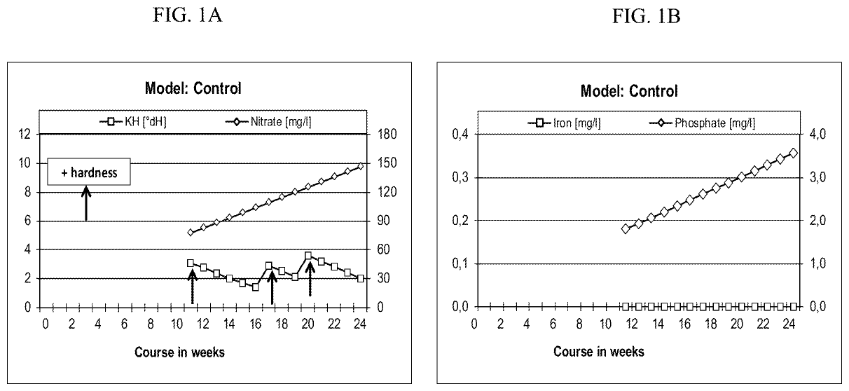

As shown in FIG. 1, at the 11^{th} week, the untreated aquarium water as a control showed a nitrate concentration of higher than about 75 mg/mL, and a phosphate concentration of higher than about 1.8 mg/L. The nitrate and phosphate constantly increased in the following weeks, reaching respectively about 150 mg/L and more than 3.5 mg/L at the 25^{th} week. It was also found that the carbonate hardness KH remained in a range from about 1.5° dH to about 4° dH, indicating that the KH value could be compensated by sodium bicarbonate. Otherwise the KH value would have been zero.

Compared to the control, Example 1 containing about 4% of PCL, about 1% of iron (III) citrate, and about 5.65% of neutralized fruit acids showed significant improvement of water quality. Application of composition of Example 1 to the prepared tank was performed in a frequency of once per week in the first month (4 weeks), with a dosage of each application of 25 mL per 100 L aquarium water. The total application of Example 1 is therefore 100 mL per 100 L aquarium water. It was found that treated aquarium water with Example 1 showed a nitrate concentration constantly below 20 mg/mL from the 11^{th} week all the way to the 25^{th} week, significantly lower than the control. The phosphate concentration was found to be only about 0.5 mg/L at the 11th week, significantly lower compared to the control. The phosphate concentration slightly increased in the following weeks, but only reached about 1.1 mg/L at the 25^{th} week. The carbonate hardness HK increased from about 6° dH at the 11th week to about 11° dH at the 25^{th} week, significantly higher than the control. The iron concentration was found to be at a level that has no detectable effect, that is less than 0.2 mg/L. These results indicated a significant improvement of water quality by treating aquarium water with compositions comprising PCL, iron citrate, and neutralized fruit acids, as represented by Example 1.

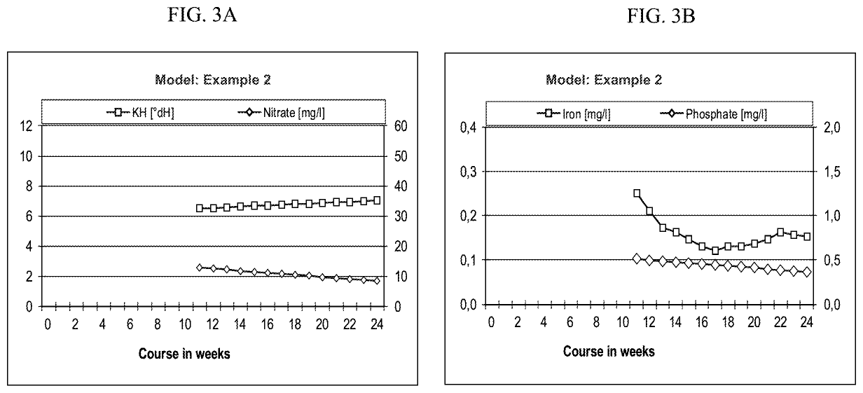

Example 2 comprises about 2% of PCL, about 0.425% iron citrate, about 2.56% of neutralized fruit acids, about 0.019% to about 0.12% of iron(III)-EDTA, and about 1.75% of tea tree oil. Application of Example 2 composition to the prepared tank was performed in a frequency of once per week in the first month (4 weeks), with a dosage of each application of 50 mL per 100 L aquarium water. The total application of Example 2 is therefore 200 mL per 100 L aquarium water. It is noted that the concentrations of PCL, iron citrate, and neutralized fruit acids of Example 2 are respectively about a half of those of Example 1, but the total dosage of the composition applied in the first month (4 times) was double compared with Example 1. Accordingly, the total amount of PCL, iron nitrate, and neutralized applied in Example 1 and Example 2 are about the same to 100 L of aquarium water. Compared with Example 1, Example 2 further comprises a metal chelating agent iron(III)-EDTA and tea tree oil. As shown in FIG. 3, it was surprisingly found that the nitrate concentration was constantly below 15 mg/mL starting at the 11^{th} week, slightly declining in the following weeks and reaching less than 10 mg/L at the 25th week. The phosphate concentration was constantly lower than about 0.5 mg/L with a declining trend from the 11^{th} week to the 25^{th} week, which indicates a significant improvement over Example 1. The carbonate hardness HK was found to be unexpectedly stable, between about 6° dH and about 7° dH from the 11^{th} week to the 25^{th} week, which indicates a significantly more stable carbonate hardness compared with Example 1 (6-11° dH). The Fe(III)-EDTA concentration of Example 2 was initially 1.2 g/L, and was reduced to a range of about 0.2-0.4 g/L in the 11^{th} week, in order to avoid excessive soluble Fe in aquarium water. Consequently, the iron concentration of the treated aquarium water declined in the next 3 weeks following the 11^{th} week to about 0.75 mg/mL but maintained about constant between 0.6-0.75 mg/L thereafter. While not wishing to be bound by theory, it is believed that the metal chelating agent iron(III)-EDTA and/or the tea tree oil of Example 2 unexpectedly increased the soluble free iron in aquarium water, and further contributed to the improvement of elimination phosphate as well as the stabilization of carbonate hardness.

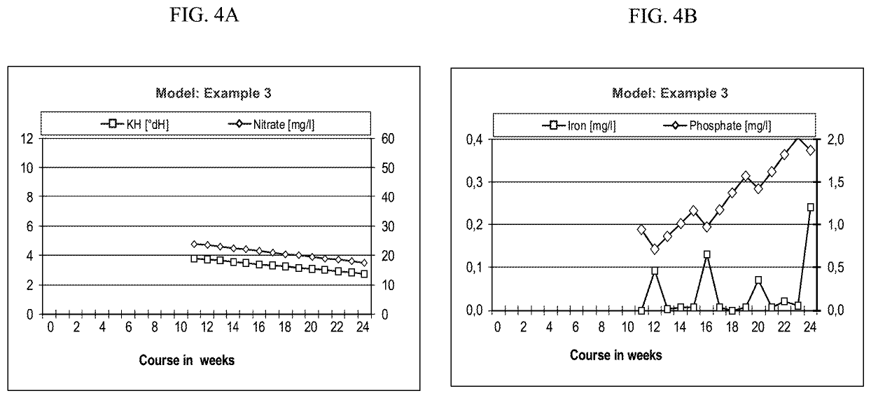

Example 3 contains about 4% of PCL, about 0.5% of iron citrate, and about 2.56% of neutralized fruit acids. Application of the composition of Example 3 to the prepared tank was performed once in the first month, with a single total dosage of 100 mL per 100 L aquarium water. It is noted that the concentrations of iron citrate and neutralized fruit acids of Example 3 were respectively about a half of those of Example 2. Accordingly, the total amount of iron citrate and neutralized fruit acids applied in Example 3 were about a half of those of Example 1 in the first month. As shown in FIG. 4, the nitrate concentration declined and remained below about 25 mg/L, and the KH value maintained between about 2° dH to about 4° dH. However, the phosphate concentration increased significantly after application and reached about 2 mg/L at the 25^{th} week. The iron concentration was in obvious fluctuation after treatment, however less than 0.1 mg/L for most weeks. The fluctuation may be caused by the slow process of precipitation of iron salts.

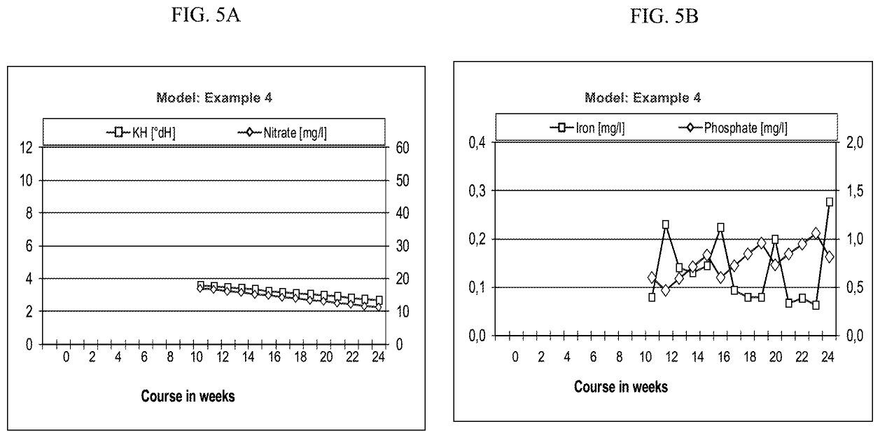

Example 4 contains about 4% of PCL, about 0.5% of iron citrate, and about 2.56% of neutralized fruit acids, and about 0.049% of methylglycinediacetic acid (MGDA). Application of the composition of Example 4 was performed in the same way as Example 3. As shown in FIGS. 5A and 5B, the nitrate concentration and KH value were not significantly different from Example 3. However, it was surprisingly found that the phosphate concentration was constantly maintained below about 1 mg/L, which indicates a significant improvement compared with Example 3. Furthermore, the soluble iron concentration was between about 0.1 to about 0.3 mg/L, significantly higher than that of Example 3. These results indicate that the metal chelating agent MGDA contributed to the increase of free iron and the improvement of phosphate elimination. The results also demonstrate that the present method of treating aquarium water can improve efficiency by application of the composition in a much lower frequency such as once per month.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

1. A composition for treating aquarium water comprising:
a first formulation for reducing or removing inorganic nitrogen, inorganic phosphorus, or mixtures thereof in aquarium water, the first formulation comprising a biodegradable polyester and a metal carboxylate;
one or more metal chelating agents; and
a buffer.

2. (canceled)

3. The composition of claim 1, wherein the metal chelating agent is a complex agent comprising one or more chelating units.

4. The composition of claim 2, wherein the chelating unit of the chelating agent is N(CH(R¹)R²COOH) or conjugate anion thereof, wherein R¹ is H or an alkyl group, and R² is absent or an alkyl group.

5. The composition of claim 1, wherein the metal chelating agent further comprises a metal ion selected from the group consisting of Na⁺, K⁺, Al³⁺, Fe³⁺, La³⁺, TiO²⁺, ZrO²⁺, Cu²⁺, Zn²⁺, Ca²⁺, Mg²⁺, Li⁺, and combinations thereof.

6. The composition of claim 1, wherein the metal chelating agent is selected from the group consisting of EDTA, Fe(III)-EDTA, Al(III)-EDTA, MGDA, Fe(III)-MGDA, Al(III)-MGDA, and combinations thereof.

7. (canceled)

8. The composition of claim 1, wherein the metal chelating agent is from about 0.01 wt % to about 0.15 wt % based on the total weight of the composition.

9. The composition of claim 1, further comprising a tea tree oil or extract thereof.

10. (canceled)

11. The composition of claim 7, wherein the tea tree oil is from about 0.01 wt % to about 1 wt % based on the total weight of the composition.

12. The composition of claim 1, further comprising a second formulation consisting essentially of a tea tree oil, a solvent, and a co-emulsifier, wherein the solvent is selected from the group consisting of glycerol, 1,2-propylene glycol, propylene glycol, dipropylene glycol, hexylene glycol, and combinations thereof, wherein the co-emulsifier is selected from the group consisting of cornstarch, cellulose, carboxymethyl cellulose (CMC), pre-gelatinized starch, arrowroot, agar-agar, carrageenan, gum arabic, gum acacin, gum tragacanth, pectin, and combinations thereof.

13. (canceled)

14. The composition of claim 1, wherein the biodegradable polyester is polycaprolactone.

15. The composition of claim 10, wherein the polycaprolactone is in a form of fine granule.

16. The composition of any of claim 1, wherein the biodegradable polyester is from about 0.1 wt % to about 10 wt % based on the total weight of the composition.

17. (canceled)

18. The composition of claim 1, wherein the metal carboxylate is Fe(III)-citrate, Al(III)-citrate, or combinations thereof.

19. The composition of claim 1, wherein the metal carboxylate is from about 0.01 wt % to about 5 wt %, wherein the wt % is calculated based on the total weight of the aqueous composition.

20. (canceled)

21. The composition of claim 1, wherein the buffer is from about 0.1 wt % to about 20 wt %, wherein the wt % is calculated based on the total weight of the aqueous composition.

22. The composition of claim 1, further comprising a thickener selected from the group consisting of cornstarch, cellulose, carboxymethyl cellulose (CMC), pre-gelatinized starch, arrowroot, agar-agar, carrageenan, gum arabic, gum acacin, gum tragacanth, pectin, xanthan gum, and combinations thereof, wherein the thickener is from about 0.05 wt % to about 1 wt %, wherein the wt % is calculated based on the total weight of the aqueous composition.

23. (canceled)

24. The composition of claim 1, further comprising a vitamin concentrate from about 0.1 wt % to about 5 wt % based on the total weight of the aqueous composition.

25. The composition of claim 1, further comprising from about 0.05 wt % to about 1 wt % of a preservative selected from the group consisting of potassium sorbate, Butrol 1060, and combinations thereof.

26. (canceled)

27. An aqueous composition for treating aquarium water comprising:
a first formulation, a buffer, one or more metal chelating agent, and water,
wherein the first formulation comprises a first agent and a second agent, wherein the first agent comprises a biodegradable polyester, wherein the first agent is from about 0.1 wt % to about 10 wt %;
wherein the second agent comprises a metal carboxylate, wherein the second agent is from about 0.01 wt % to about 5 wt %;
wherein the buffer comprises one or more neutralized fruit acid(s), wherein the buffer is from about 0.1 wt %; and
wherein the metal chelating agent comprises one or more N(CH(R¹)R²COOH) or conjugate anion thereof, wherein R¹ is H or alkyl group, and R² is absent or an alkyl group, and wherein the metal chelating agent is from about 0.001 wt % to about 1 wt %,
wherein the wt % is based on the total weight of the composition.

28. (canceled)

29. The composition of claim 19 further comprising a second formulation consisting essentially of from about 0.01 wt % to about 0.1 wt % of a tea tree oil, from about 1 wt % to about 3 wt % of 1,2-propylene glycol, and from about 0.01 wt % to about 0.05 wt % of carrageenan, wherein the wt % is calculated based on the total weight of the composition.

30. The composition of any of claim 19, wherein the metal chelating agent further comprises a metal ion selected from Fe³⁺, Al³⁺, or combination thereof.

31. (canceled)

32. (canceled)

33. (canceled)

34. A method of treating aquarium water comprising:
adding an aqueous composition to aquarium water, wherein the aqueous composition comprises:
a first formulation, a buffer, one or more metal chelating agent, and water,
wherein the first formulation comprises a first agent and a second agent, wherein the first agent comprises a biodegradable polyester, wherein the first agent is from about 0.1 wt % to about 10 wt %;
wherein the buffer comprises one or more neutralized fruit acid(s), wherein the buffer is from about 0.1 wt % to about 20 wt %; and
wherein the metal chelating agent comprises one or more N(CH(R¹)R²COOH) or conjugate anion thereof, wherein R¹ is H or alkyl group, and R² is absent or an alkyl group, and wherein the metal chelating agent is from about 0.001 wt % to about 1 wt %,
wherein the wt % is based on the total weight of the composition; and
(ii) reducing or removing inorganic nitrogen, inorganic phosphorus, or mixtures thereof in the aquarium water.

35. The method of claim 22, wherein the aqueous composition further comprises a second formulation consisting essentially of from about 0.01 wt % to about 1 wt % of a tea tree oil, from about 1 wt % to about 3 wt % of a solvent, and from about 0.01 wt % to about 0.05 wt % of a co-emulsifier, wherein the wt % is calculated based on the total weight of the composition.

36. (canceled)

37. The method of claim 22, wherein the metal chelating agent is selected from the group consisting of EDTA, Fe(III)-EDTA, Al(III)-EDTA, MGDA, Fe(III)-MGDA, Al(III)-MGDA, and combinations thereof.

38. The method of claim 22, wherein the composition further comprises a thickener selected from the group consisting of cornstarch, cellulose, carboxymethyl cellulose (CMC), pre-gelatinized starch, arrowroot, agar-agar, carrageenan, gum arabic, gum acacin, gum tragacanth, pectin, and combinations thereof, and wherein the thickener is from about 0.05 wt % to about 1 wt %, wherein the wt % is calculated based on the total weight of the composition.

39. The method of claim 22, wherein the composition further comprises a mineral concentrate from about 0.1 wt % to about 5 wt % based on the total weight of the aqueous composition.

40. The method of claim 22, wherein the composition further comprises a vitamin concentrate from about 0.1 wt % to about 5 wt % based on the total weight of the aqueous composition.

41-50. (canceled)
